(19) United States
(12) Patent Application Publication
(10) Pub. No.: US 2024/0214774 A1
(43) Pub. Date: Jun. 27, 2024

(54) Altitude Enhanced Geofence

(71) Applicant: Google LLC, Mountain View, CA (US)

(72) Inventors: Andrew Larsen Axley, Bend, OR (US); Erin Rebecca Griffiths, Santa Clara, CA (US)

(73) Assignee: Google LLC, Mountain View, CA (US)

(21) Appl. No.: 18/598,939

(22) Filed: Mar. 7, 2024

Related U.S. Application Data
(60) Provisional application No. 63/561,634, filed on Mar. 5, 2024.

(51) Int. Cl. H04W 4/021; H04W 4/38; H04W 24/08; H04W 64/00

(52) U.S. Cl. CPC H04W 4/021; H04W 4/38; H04W 24/08; H04W 64/00

(57) ABSTRACT

This document describes systems and techniques directed at an altitude enhanced geofence. In aspects, a geofence manager maintains a three-dimensional virtual boundary for a geographic area associated with a user. The geofence manager determines a spatial positioning of a portable electronic device associated with the user relative to the virtual boundary. Based on a determination that the portable electronic device is within a horizontal boundary of the virtual boundary, the geofence manager monitors a barometric pressure surrounding the portable electronic device using information from at least one sensor associated with the portable electronic device. The geofence manager can determine an altitude of the portable electronic device based on the monitored pressure and initiate one or more functions if the altitude indicates the portable electronic device is within a vertical boundary of the virtual boundary. Through such techniques, the geofence manager can increase the accuracy and reliability of geofencing systems.

### CROSS-REFERENCE TO RELATED APPLICATION(S)

This application claims the benefit of U.S. Provisional Patent Application Ser. No. 63/561,634, filed on Mar. 5, 2024, the disclosure of which is incorporated by reference herein in its entirety.

### SUMMARY

This document describes systems and techniques directed at an altitude enhanced geofence. In aspects, a geofence manager maintains a virtual boundary that extends in three dimensions for a geographic area associated with a user. The geofence manager further determines a spatial positioning of a portable electronic device associated with the user relative to the virtual boundary. Based on a determination that the portable electronic device is within a horizontal boundary of the virtual boundary, the geofence manager monitors a barometric pressure surrounding the portable electronic device using information received by at least one sensor associated with the portable electronic device. The geofence manager can then determine an altitude of the portable electronic device based on the monitored barometric pressure and initiate one or more functions if the altitude is indicative of the portable electronic device being within a vertical boundary of the virtual boundary. Through such techniques, the geofence manager can increase the accuracy and reliability of geofencing systems.

In aspects, a method is disclosed that includes a geofence manager maintaining a virtual boundary for a geographic area associated with a user. The virtual boundary extends in three dimensions and includes a horizontal boundary and a vertical boundary. The horizontal boundary is defined by a length and a width of the virtual boundary, and the vertical boundary is defined by a height of the virtual boundary. The geofence manager determines, with respect to the horizontal boundary, a location of a portable electronic device associated with the user. In response to determining that the location of the portable electronic device is within the horizontal boundary, the geofence manager monitors a barometric pressure surrounding the portable electronic device based on information received by at least one sensor integrated within the portable electronic device. The geofence manager further determines an altitude of the portable electronic device based on the barometric pressure. In response to determining that the altitude of the portable electronic device is within the vertical boundary, the geofence manager may initiate one or more functions.

This Summary is provided to introduce simplified concepts for an altitude enhanced geofence, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for an altitude enhanced geofence are described in this document with reference to the following drawings:

FIG. 1 illustrates an example environment in which techniques for an altitude enhanced geofence can be implemented;

FIG. 2 illustrates an example operating environment of an example portable electronic device capable of implementing aspects of an altitude enhanced geofence;

FIG. 3 illustrates an example implementation of an example geofence directed at implementing an altitude enhanced geofence;

FIG. 4 illustrates an example environment in which techniques for an altitude enhanced geofence can be implemented; and

FIG. 5 illustrates an example method directed at implementing an altitude enhanced geofence.

The use of same numbers in different instances may indicate similar features or components.

### DETAILED DESCRIPTION

### Overview

Users in high-rise buildings or multi-floored apartment complexes may encounter challenges while using geofencing features with their smarthome networks. For instance, a user may dwell on a fifth story of a multi-floored apartment complex. The user's dwelling may include one or more network-connected devices that utilize a geofencing system to trigger automations, such as a door lock, a light activation, and so on. While the geofencing system may approximately determine a spatial positioning of a user's portable electronic device with respect to, for example, a longitude and a latitude, the geofencing system may have more difficulty determining (or may not even consider) an altitude of the portable electronic device. Without accurate information regarding a spatial positioning of a user's portable electronic device with respect to altitude, the geofencing system may inadvertently activate location-based triggers that unintentionally enable or disable automations in a smarthome.

Some solutions may utilize a global positioning system to identify a spatial positioning of a portable electronic device in relation to a geofence. For example, a geofence may be set around a user's smarthome environment, and a user may have location-based triggers activated such that a smart door lock automatically unlocks when their portable electronic device is within a certain distance of the smarthome environment (e.g., as determined using a global positioning system). In this way, as the user approaches an entryway to their smarthome environment, the smart door lock can unlock to facilitate user entry. In such a scenario, the user may appreciate the usefulness of the geofence and the location-based triggers, particularly if the user lives on the ground floor of a building. However, if the user's smarthome environment is located on a second floor of a building or higher, then location-based triggers can oftentimes be activated when the portable electronic device is at a different altitude than the smarthome environment. This may be due to the global positioning system's imprecision with respect to an altitude (or height) of a portable electronic device. As a result, location-based triggers may undesirably activate (e.g., a smart door may automatically unlock despite a portable electronic device and a user being on a different floor), which may lead to security concerns for the user.

To this end, this document describes techniques and systems for an altitude enhanced geofence. A geofence manager maintains a virtual boundary around a geographic area associated with a user and determines a spatial positioning of a portable electronic device associated with a user relative to the virtual boundary. Based on a determination that the portable electronic device is within a horizontal boundary of the virtual boundary, the geofence manager monitors barometric pressure surrounding the portable electronic device and determines an altitude of the portable electronic device based on the pressure levels. After the geofence manager determines that the portable electronic device is within a vertical boundary of the virtual boundary, the geofence manager can initiate one or more functions. For example, a user may live on the fourth floor of an apartment building. A geofence manager may determine that the user is in the building, but not on their floor level, and may monitor barometric pressure. The user may enter into an elevator that takes them to the fourth floor, which indicates to the geofence manager that the portable electronic device is withing the vertical boundary. Thus, the geofence manager may initiate an activation of a smart thermostat. By so doing, the techniques can increase the accuracy and reliability of geofencing systems.

### Operating Environment

The following discussion describes an operating environment, techniques that may be employed in the operating environment, and various devices or systems in which components of the operating environment can be embodied. In the context of the present disclosure, reference is made to the operating environment by way of example only.

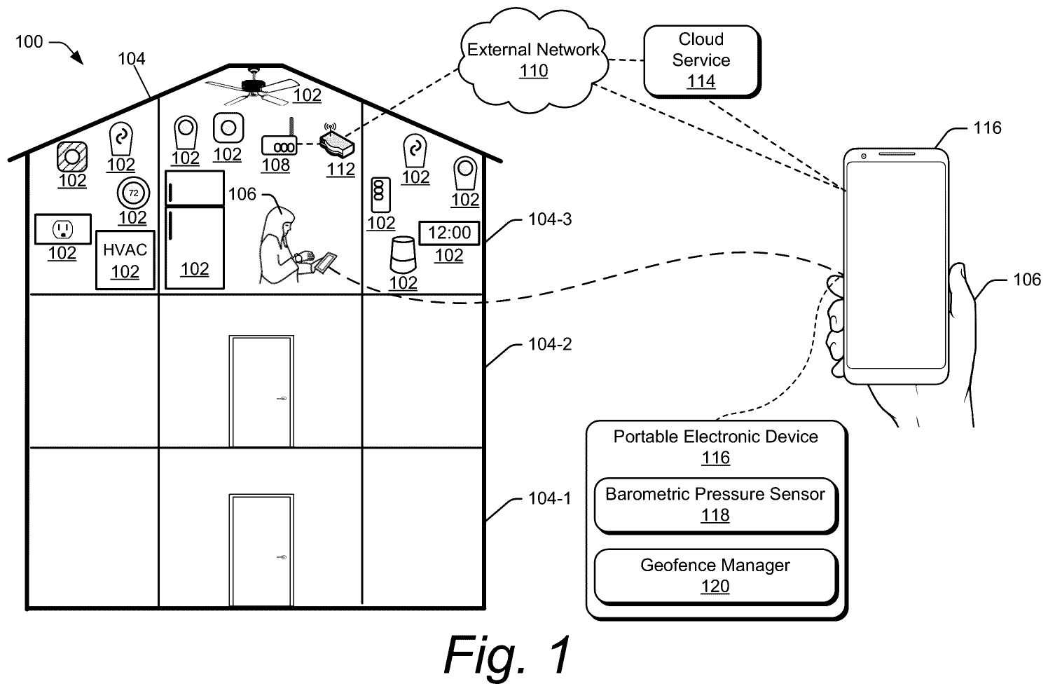

FIG. 1 illustrates an example environment 100 in which a network of network-connected devices and aspects of an altitude enhanced geofence can be implemented. Generally, the environment 100 includes the network (e.g., a home area network (HAN)) implemented as part of a home or other type of structure with any number of network-connected devices 102 that are configured for communication in a wireless network. For example, the network-connected devices 102 can include, as non-limiting examples, thermostats, hazard detectors (e.g., for smoke and/or carbon monoxide), cameras, lighting units, sensors and detectors (e.g., ambient light detectors, occupancy sensors, doorbells, door lock system), connected appliances and/or controlled systems (e.g., refrigerators, stoves, ovens, washers, dryers, air conditioners, pool heaters, irrigation systems, security systems), electronic and computing devices (e.g., televisions, entertainment systems, computers, speakers, intercom systems, garage-door openers, alarm clocks, ceiling fans, control panels), and any other types of network-connected devices that are implemented inside and/or outside of a structure 104 (e.g., in a home environment). As illustrated, for example only, the structure 104 includes three stories, a first story 104-1, a second story 104-2, and a third story 104-3. A user 106 may reside on the third story 104-3 and may possess or utilize any number of network-connected devices 102. One or more of the network-connected devices 102 may be a smart device, which may define the environment 100 as a smarthome environment.

In the environment 100, any number of the network-connected devices 102 can be implemented for wireless interconnection to wirelessly communicate and interact with each other. The network-connected devices 102 may be modular, intelligent, multi-sensing, wireless devices that can integrate seamlessly with each other and/or with a central server or a cloud-computing system to provide any of a variety of useful automation objectives and implementations. The network-connected devices 102 can also be configured to communicate via the network, which may include a wireless mesh network, a Wi-Fi network, or both.

As illustrated, the environment 100 includes a border router 108 that interfaces with an external network 110 for wireless communication. The border router 108 connects to an access point 112, which connects to the external network 110, such as the Internet. A cloud service 114, which is connected via the external network 110, may provide services related to and/or using the devices within the network. By way of example, the cloud service 114 can include applications for connecting portable electronic devices 116, such as smartphones, tablets, wearable devices, and the like, to devices in the network, processing and presenting data acquired in the network to end-users, linking devices in one or more networks to user accounts of the cloud service 114, provisioning and updating devices in the network, and so forth. For example, a user 106 can control the network-connected devices 102 in the environment 100 using a portable electronic device 116 (which may also be a network-connected device 102), such as a smartphone (e.g., a mobile phone) or tablet device. Further, the network-connected devices 102 can communicate information to any central server or cloud-computing system via the border router 108 and the access point 112. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

In implementations, the user 106 can manage, control, and/or view information related to the environment 100 (e.g., smarthome environment), including one or more network-connected devices 102, using the portable electronic device 116. The portable electronic device 116 may include a barometric pressure sensor 118 (or other pressure sensing device) to measure a barometric pressure surrounding the portable electronic device 116 and a geofence manager 120 to maintain a virtual boundary (not illustrated) for a geographic area associated with the user 106. The geofence manager 120 may additionally determine a location (e.g., a longitude, a latitude) of the portable electronic device 116. Based on a determination that the location of the portable electronic device 116 is within a horizontal boundary of the virtual boundary, the geofence manager 120 may obtain and monitor pressure readings surrounding the portable electronic device 116 using the barometric pressure sensor 118. The geofence manager 120 may further determine an altitude of the portable electronic device 116 based on the monitored barometric pressure. In response to determining that the portable electronic device 116 is located within a vertical boundary of the virtual boundary, the geofence manager 120 may initiate one or more functions causing at least one action by at least one of the network-connected devices 102 (e.g., the portable electronic device 116, a door lock).

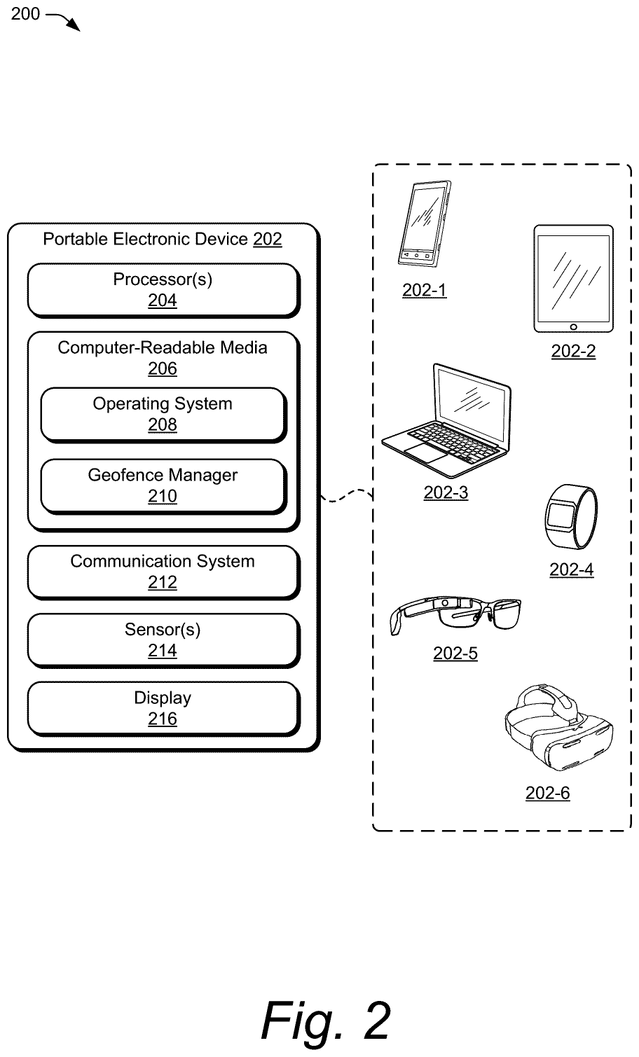

FIG. 2 illustrates an example operating environment 200 that includes an example portable electronic device 202 that is capable of implementing aspects of an altitude enhanced geofence in accordance with one or more implementations. Examples of a portable electronic device 202 include a smartphone 202-1, a tablet 202-2, a laptop 202-3, a smart watch 202-4, smart-glasses 202-5, and virtual-reality (VR) goggles 202-6. Note that the portable electronic device 202 can be wearable or non-wearable but mobile. The portable electronic device 202 may include components or interfaces omitted from FIG. 2 for the sake of clarity or visual brevity.

As illustrated, the portable electronic device 202 includes one or more processors 204 and computer-readable media 206. The processors 204 may include any suitable single-core or multi-core processor (e.g., an application processor (AP), a digital-signal processor (DSP), a central processing unit (CPU), graphics processing unit (GPU)). The processors 204 may be configured to execute instructions or commands stored within computer-readable media 206. The computer-readable media 206 can include an operating system 208 and a geofence manager 210 (e.g., geofence manager 120). In implementations (not illustrated), the geofence manager 210 can be implemented, partially or completely, on a cloud service (e.g., cloud service 114) and/or any other network-connected device 102 from environment 100.

Applications (not shown) and/or the operating system 208 implemented as computer-readable instructions on the computer-readable media 206 can be executed by the processors 204 to provide some or all of the functionalities described herein. The computer-readable media 206 may be stored within one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The portable electronic device 202 may further include and/or be operatively coupled to communication systems 212. The communication systems 212 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of the various IEEE 802.11 (WiFi®) standards, WWAN (3GPP-compliant) radios for cellular telephony, wireless metropolitan area network (WMAN) radios compliant with various IEEE 802.16 (WiMAX®) standards, and infrared (IR) transceivers compliant with an Infrared Data Association (IrDA) protocol. Device data communicated over the communication systems 212 may be packetized or framed depending on a communication protocol or standard by which the portable electronic device 202 is communicating. Alternatively or additionally, the communication systems 212 may include wireless interfaces that facilitate communication over wireless networks, such as wireless LANs, cellular networks, or WPANs.

The portable electronic device 202 may further include and/or be operatively coupled to one or more sensors 214 (e.g., barometric pressure sensor 118). The one or more sensors 214 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), barometric sensors (e.g., a barometer), or an ambient light sensor (e.g., photodetector). In implementations, the portable electronic device 202 can use the one or more sensors 214 to monitor barometric pressure levels (e.g., directly, indirectly) around the portable electronic device 202.

The portable electronic device 202 may also include a display 216. In some implementations, the portable electronic device 202 can present a barometric reading on the display 216. Using the display 216, the geofence manager 210 can provide a barometric pressure reading to a user and implement functions in a smarthome environment based on a maintained virtual boundary (e.g., altitude enhanced geofence).

It will be appreciated by one skilled in the art that components and functions described herein may be further divided and/or combined across one or more network-connected devices, including the portable electronic device 202, other network-connected devices 102, and/or the cloud service 114.

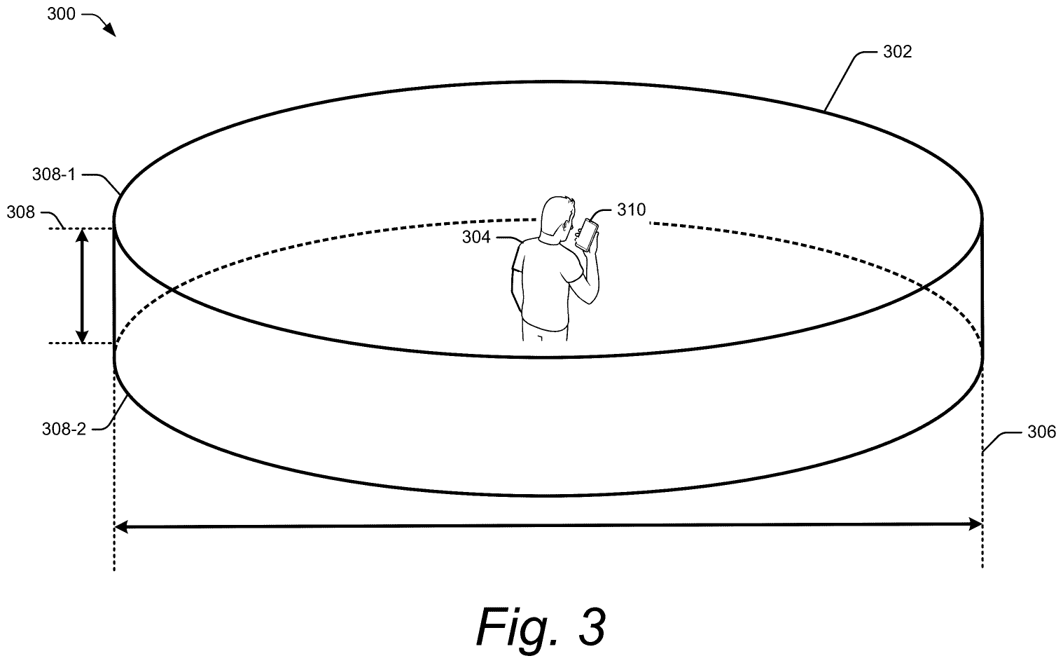

FIG. 3 illustrates an example environment 300 of an example altitude enhanced geofence in accordance with one or more implementations. In aspects, an altitude enhanced geofence defines a virtual boundary 302 extending in three-dimensions (e.g., a length, a width, a height). The virtual boundary 302 may cover a geographic area associated with a user 304. In at least some implementations, the geographic area includes a smarthome environment (e.g., environment 100) associated with a user 304.

The virtual boundary 302 may be defined by a horizontal boundary 306 and a vertical boundary 308. In implementations, the horizontal boundary 306 defines a length and a width of the virtual boundary 302, while the vertical boundary 308 defines a height of the virtual boundary 302. In further implementations, the height of the virtual boundary 302 is a distance between a first end 308-1 and a second end 308-2 (e.g., a top and a bottom) of the vertical boundary 308. In one example, the virtual boundary 302 may take the form of a cylinder, where the first end 308-1 is a top of the cylindrical virtual boundary 302 and the second end 308-2 is a bottom of the cylindrical virtual boundary 302. In additional examples (not illustrated), the virtual boundary 302 may take the form of a diamond, a rectangular prism, and so on. In implementations, the width of the virtual boundary 302 may be larger than the height of the virtual boundary 302. For example, the width (and length) may be 50 feet (e.g., based on a precision of global positioning system or cellular triangulation) and the height may be 10 feet (e.g., based on a precision of the barometric pressure sensor, a conversion accuracy from barometric pressure to altitude, weather patterns within the vicinity of the portable electronic device 310). In at least some implementations, the horizontal boundary 306 is parallel with a tangential plane defined by a surface of the earth, and the vertical boundary 308 is perpendicular to the horizontal boundary 306.

In aspects, a geofence manager (e.g., geofence manager 210) maintains the virtual boundary 302. The geofence manager may determine a location of a portable electronic device 310 with respect to the horizontal boundary 306. In response to determining that the portable electronic device 310 is within the horizontal boundary 306, the geofence manager may begin to monitor a barometric pressure surrounding the portable electronic device 310. The portable electronic device 310 may include and/or be coupled to one or more sensors (e.g., the one or more sensors 214) to measure surrounding barometric pressure levels. In at least some implementations, the geofence manager may indirectly monitor the barometric pressure. As an example, the portable electronic device 310 may include a micro-electro-mechanical system (MEMS) to receive audio input, but which also may be used (directly or indirectly) to measure pressure. In another example, a barometric sensor (e.g., the barometric pressure sensor 118) within the portable electronic device 310 may transmit barometric pressure readings to the geofence manager. Based on the barometric pressure, the geofence manager may determine an altitude of the portable electronic device 310 with respect to the vertical boundary 308.

In the scenario that the geofence manager determines that the altitude of the portable electronic device 310 is within the vertical boundary 308, the geofence manager may initiate one or more functions at the portable electronic device 310, at one or more network-connected devices 102 within the environment 100 (not illustrated), or both. In aspects, one or more functions may include triggering an automation functionality. The automation functionality may cause an action by at least one network-connected device (e.g., network-connected devices 102, the portable electronic device 310). The action may include at least one of activating a light-emitting network-connected device, unlocking a door lock assembly network-connected device, deactivating a video-capturing network-connected device, or adjusting a temperature setting on a thermostat network-connected device. In one example, a geofence manager may determine that a portable electronic device has recently repositioned to be within a vertical boundary of a virtual boundary associated with a user. In response, the geofence manager may initiate a function that triggers a smart thermostat to increase a room temperature of the user's dwelling. In another example, a geofence manager may determine that a portable electronic device associated with a user is within a vertical boundary of a virtual boundary associated with a smarthome environment and a time-based trigger has activated. In response, the geofence manager may initiate an automation function that triggers a smart blind system to open the blinds and a smart lighting system to turn on the lights.

The geofence manager may continue monitoring the barometric pressure surrounding the portable electronic device 310 after initiating a function and/or after determining that the portable electronic device is within a vertical boundary of a virtual boundary associated with a user. In implementations, the geofence manager may determine that the portable electronic device 310 is no longer within the vertical boundary 308, based on barometric pressure sensor readings, and may initiate one or more additional functions. The additional functions may include at least one of deactivating a light-emitting network-connected device, activating a video-capturing network-connected device, or adjusting a temperature setting on a thermostat network-connected device.

As another example, a user may live in a multiple-story home and may have a virtual boundary associated with each floor of the home. The user may arrive home on their ground floor, which may cause the geofence manager to initiate a door-unlocking function and activate a smart lighting system for the first floor. The user may decide to go to their second floor, where the geofence manager may determine a change in barometric pressure surrounding the user's portable electronic device. The geofence manager may determine that the portable electronic device is no longer within the vertical boundary of the virtual boundary of the ground floor and may deactivate the smart lighting system on the ground floor. Based on the change of barometric pressure, the geofence manager may determine that the portable electronic device is within a vertical boundary of a second virtual boundary and may also activate another smart lighting system on the second floor.

In a further example, a first user may live on the fourth floor of an apartment building and may have a virtual boundary maintained by a first geofence manager associated with a network of network-connected devices. The first user may be expecting a package to be delivered by a second user (e.g., a delivery person). The second user may have a second geofence manager on their portable electronic device. The second geofence manager may determine the location of the second user's portable electronic device with respect to the virtual boundary maintained by the first geofence manager. If the second geofence manager determines that the second user's portable electronic device is within a vertical boundary of the virtual boundary maintained by the first geofence manager, then the second geofence manager may cause the first geofence manager to initiate one or more functions. For example, the second geofence manager may wirelessly communicate with the first geofence manager and cause the first geofence manager to activate a video-capturing network-connected device.

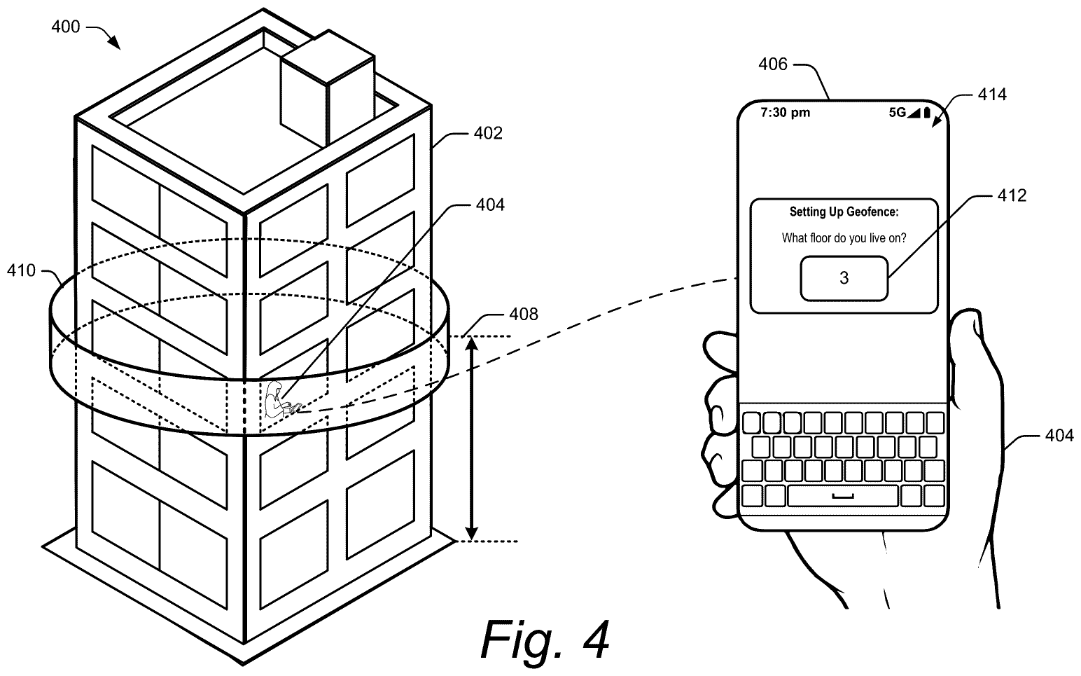

FIG. 4 illustrates an example environment 400 in which aspects of an altitude enhanced geofence can be implemented. As illustrated, the environment 400 includes a multi-floored building 402 that houses a user 404. In aspects, the user 404 can establish a geofence for their environment (e.g., environment 100, a smarthome environment) using a portable electronic device 406 while at an altitude 408 associated with their environment. Based on the altitude 408 associated with the environment as determined by a geofence manager (e.g., geofence manager 210) using a barometric pressure sensor (e.g., barometric pressure sensor 118), the geofence manager may set a midpoint of a vertical boundary (e.g., vertical boundary 308) of a virtual boundary 410 equal to the altitude 408 associated with the environment. The midpoint of the vertical boundary may be a midpoint of a distance (e.g., height) between a first end (e.g., first end 308-1) and a second end (e.g., second end 308-2) of the vertical boundary. For example, the midpoint may be an elevation of the virtual boundary 410 based on the altitude 408.

In some implementations, the altitude 408 may be determined based at least in part on user input 412. For example, the geofence manager may prompt the user 404 to enter user input 412 into a user interface 414 (e.g., at the display 216) of the portable electronic device 406. In some implementations, the user input 412 may include the floor level associated with the environment of the user 404. For example, as illustrated in FIG. 4, the user 404 inputs data into the user interface 414 indicating that they live on the third floor in the building 402. The geofence manager may then associate a barometric pressure sensor reading at the time the user established the geofence (e.g., enrollment) for their environment with the altitude 408 of the user's environment.

As another example, a user may be attending a conference with breakout rooms on different stories of a multi-stored building. One or more of the rooms may have a respective virtual boundary associated therewith. The user may decide to attend a presentation on the sixth floor of a high-rise building, and to mark the user's attendance to the presentation, a geofence manager installed on a portable electronic device associated with the user may determine that the user is within a vertical boundary of a virtual boundary associated with the room on the sixth floor of the high-rise building.

### Example Methods

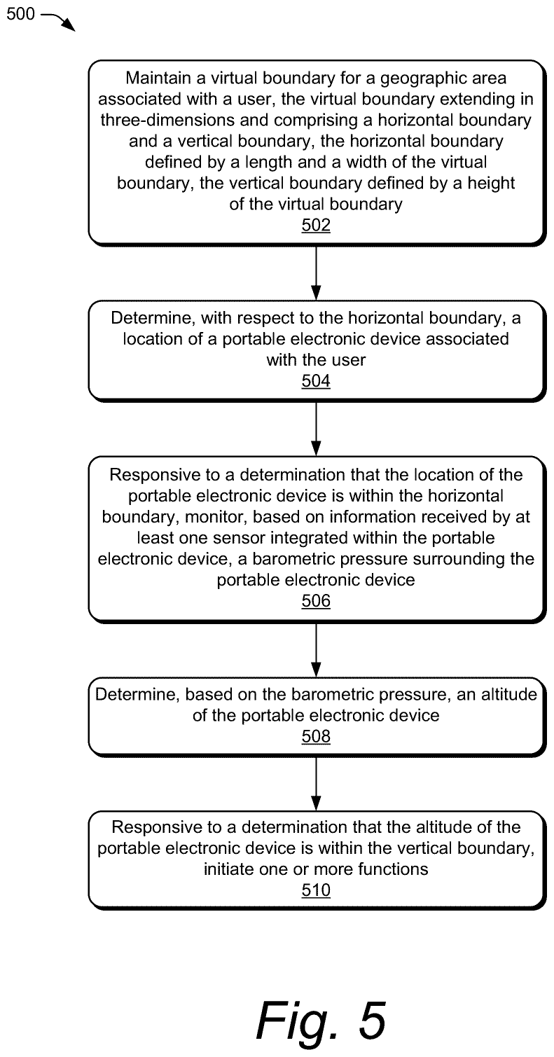

An example method 500 is shown in FIG. 5 as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, some operations of the example methods may be implemented on operating systems through an application programming interface (API). Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (AS SPs), System-on-a-chip systems (SoCs), Complex Programmable Logic Devices (CPLDs), and the like.

FIG. 5 illustrates an example method 500 for an altitude enhanced geofence in accordance with one or more implementations. At 502, a virtual boundary for a geographic area associated with a user is maintained. The virtual boundary may extend in three dimensions and may include a horizontal boundary and a vertical boundary. The horizontal boundary may be defined by a length and a width of the virtual boundary, and the vertical boundary may be defined by a height of the virtual boundary. Additionally, the horizontal boundary may be parallel with a tangential plane defined by a surface of the earth, and the vertical boundary may be perpendicular to the horizontal boundary. In at least some implementations, a geofence manager (e.g., geofence manager 210) may maintain the geographic area before the geofence manager determines a location of a portable electronic device. For example, the geofence manager may maintain a virtual boundary around a smarthome environment associated with a user. The virtual boundary may include a horizontal boundary around the smarthome environment and a vertical boundary at a floor level (e.g., altitude) of the smarthome environment.

At 504, a location of a portable electronic device associated with the user is determined. For example, the geofence manager may determine a location of a portable electronic device (e.g., portable electronic device 116). The location may be determined with respect to the horizontal boundary of the virtual boundary. For example, the geofence manager may determine that the location of the portable electronic device is within the horizontal boundary of the virtual boundary around the smarthome environment when the user walks into their apartment building with their portable electronic device.

At 506, in response to a determination that the location of the portable electronic device is within the horizontal boundary, a barometric pressure surrounding the portable electronic device is monitored. The monitoring may be based on information received by at least one sensor integrated within the portable electronic device. For example, the geofence manager may determine that the portable electronic device is within the horizontal boundary (e.g., horizontal boundary 306). The geofence manager may then monitor a barometric pressure using information from at least one sensor (e.g., one or more sensors 214). For example, the geofence manager may monitor a barometric pressure around the portable electronic device when the user walks into their apartment building with their portable electronic device.

At 508, an altitude of the portable electronic device is determined based on the barometric pressure. For example, the geofence manager may associate the barometric pressure from the at least one sensor (e.g., one or more sensors 214) with an altitude. The altitude may be determined with respect to the vertical boundary of the virtual boundary. For example, the geofence manager may monitor a change in the barometric pressure surrounding the portable electronic device when the user walks up the stairs in their apartment building. Based on the change in pressure, the geofence manager may determine an altitude of the portable electronic device.

In a further example, the geofence manager may determine an altitude of a portable electronic device associated with a user based on barometric pressure data from an API which may include first-party and/or third-party applications. The portable electronic device may have an operating system including a navigation application (e.g., a first-party application) and a geofence API (e.g., geofence manager). The user may have also installed a task management application (e.g., a third-party application) to keep track of their daily tasks. The navigation application and the task management application may integrate with the geofence API, allowing the user to set location-based tasks that are tied to their favorite geofences. For example, the user may need to buy groceries, so they create a new task to “Buy groceries” along with a grocery list. The user may further set the location to a geofence around their nearby grocery store. The task management application may register the grocery store geofence through the geofence API which may trigger the navigation application to set directions to the grocery store. The geofence API may monitor a change in barometric pressure surrounding the user's portable electronic device and may determine an altitude of the portable electronic device.

At 510, in response to a determination that the altitude of the portable electronic device is within the vertical boundary, the geofence manager may initiate one or more functions. For example, a smarthome environment (e.g., environment 100) associated with network-connected devices (e.g., network-connected devices 102) may be triggered to activate a light-emitting network-connected device when the user and their portable electronic device reaches their floor level. In another example, the geofence manager may determine that a portable electronic device is positioned at an altitude within a vertical boundary and may initiate a function through an API. For example, a user may use a navigation application to go to a grocery store, and upon reaching a geofence boundary of the grocery store, the navigation application may trigger a task management application through a geofence API to send a notification to the user. The notification may include a task name (e.g., “Buy groceries”) and a description (e.g., the grocery list). In a further example, the geofence manager may determine that an altitude of a portable electronic device is within a vertical boundary and, in response, may push that information to a remote device (e.g., cloud service 114). After receiving the new information, the remote device may initiate one or more functions. For example, a delivery vehicle may include a geofence manager that may determine that the vehicle is within a vertical boundary of a geofence. The geofence manager may push this information to a cloud-based fleet management system. After receiving the information that the delivery vehicle has entered the geofence boundary, the fleet management system may process the information and may mark the vehicle as “arrived” along with a timestamp and an associated vehicle ID.

### Conclusion

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of an altitude enhanced geofence have been described in language specific to techniques and/or systems, it is to be understood that the subject of the appended claims is not necessarily limited to the specific techniques or methods described. Rather, the specific techniques and methods are disclosed as example implementations for an altitude enhanced geofence.

What is claimed is:

1. A method comprising:
maintaining a virtual boundary for a geographic area associated with a user, the virtual boundary extending in three-dimensions and comprising a horizontal boundary and a vertical boundary, the horizontal boundary defined by a length and a width of the virtual boundary, the vertical boundary defined by a height of the virtual boundary;
determining, with respect to the horizontal boundary, a location of a portable electronic device associated with the user;
responsive to a determination that the location of the portable electronic device is within the horizontal boundary, monitoring, based on information received by at least one sensor integrated within the portable electronic device, a barometric pressure surrounding the portable electronic device;
determining, based on the barometric pressure, an altitude of the portable electronic device; and
responsive to a determination that the altitude of the portable electronic device is within the vertical boundary, initiating one or more functions.

2. The method of claim 1, wherein:
the horizontal boundary is parallel with a tangential plane defined by a surface of the earth; and
the vertical boundary is perpendicular to the horizontal boundary.

3. The method of claim 1, wherein the monitoring, based on the at least one sensor integrated within the portable electronic device, indirectly monitors the barometric pressure surrounding the portable electronic device.

4. The method of claim 1, wherein:
the geographic area associated with the user comprises a smarthome environment, the smarthome environment comprising a plurality of network-connected devices; and
the initiating one or more functions comprises triggering an automation functionality sufficient to cause at least one action by at least one network-connected device of the plurality of network-connected devices.

5. The method of claim 4, wherein triggering the automation functionality sufficient to cause at least one action comprises at least of one:
activating a light-emitting network-connected device;
unlocking a door lock assembly network-connected device;
deactivating a video-capturing network-connected device; or
adjusting a temperature setting on a thermostat network-connected device.

6. The method of claim 1, further comprising:
prior to maintaining the virtual boundary, determining an elevation and a height of the vertical boundary through at least one of:
receiving user input indicative of a floor story associated with the geographic area; or
obtaining an initial barometric pressure surrounding the geographic area during an enrollment process or a calibration sequence.

7. The method of claim 6, wherein:
the elevation comprises a midpoint of the vertical boundary; and
the height comprises a distance from a first end of the vertical boundary to a second end of the vertical boundary.

8. The method of claim 1, further comprising:
monitoring, responsive to initiating the one or more functions, the barometric pressure surrounding the portable electronic device;
determining, based on the barometric pressure, an altitude of the portable electronic device; and
responsive to a determination that the altitude of the portable electronic device is outside the vertical boundary, initiating one or more additional functions, the one or more additional functions comprising at least one of:
deactivating a light-emitting network-connected device;
locking a door lock assembly network-connected device;
activating a video-capturing network-connected device; or
adjusting a temperature setting on a thermostat network-connected device.
